(19) United States
(12) Patent Application Publication
(10) Pub. No.: US 2025/0212867 A1
(43) Pub. Date: Jul. 3, 2025

(54) CALIBRATION OF MACHINING TOOLS FOR A PRECISION AGRICULTURE

(71) Applicant: BAYER AKTIENGESELLSCHAFT, Leverkusen (DE)

(72) Inventors: Matthias TEMPEL, Leverkusen (DE); Josef EXLER, Leverkusen (DE)

(21) Appl. No.: 18/841,816

(22) PCT Filed: Feb. 21, 2023
(86) PCT No.: PCT/EP2023/054270

§ 371 Date: Aug. 27, 2024

(30) Foreign Application Priority Data
Feb. 28, 2022 (EP) 22159164.7
Sep. 1, 2022 (EP) 22193459.9

(51) Int. Cl. A01M 7/00; A01B 79/00

(52) U.S. Cl. CPC A01M 7/0089; A01B 79/005

(57) ABSTRACT

The present invention relates to the technical field of precision agriculture. The present invention relates to a method, a computer system, a computer program product and a system for calibrating a machining tool. The method (100) according to the invention comprises the steps of: creating a digital measure map for a region of the earth's surface (110), transmitting the digital measure map to the at least one machining tool (120), receiving a result (130), determining a deviation between the actual partial region and the target partial region (140), and modifying the at least one value of the at least one device parameter with respect to a reduced deviation and/or modifying the digital measure map with respect to a reduced deviation (150).

The present invention relates to the technical field of precision agriculture. The subject matter of the present invention provides a method, a computer system, a computer program product and a system for calibrating a processing machine.

Precision farming is the term used to describe methods for the spatially-differentiated and targeted management of agricultural land areas.

The practice of precision agriculture has been made possible by the introduction of satellite-based positioning. Using remote sensing data and/or sensors within a field and/or sensors on processing machines moving in the field, a variety of properties can be acquired with high spatial resolution for various sub-regions in an agricultural region, such as crop yield, terrain features/topography, organic matter content, moisture, nitrogen content, pH value, soil composition, weed distribution and much more.

Digital feature maps can be created based on the properties acquired, which show the variability of an agricultural land area in a spatially resolved manner.

For example, such a feature map may record positions in which weeds have been detected. In another example, such a feature map may record sub-regions that are comparatively dry. In another example, such a feature map may record sub-regions that have a comparatively low crop yield.

On the basis of such feature maps, different actions can be planned for different sub-regions, which take account of the variability. Digital action maps can be created on the basis of such feature maps. A digital action map may include instructions as to which actions are to be taken in which sub-regions and/or at which positions in an agricultural region. For example, such an action map may provide for the application of a herbicide at the positions at which a weed has been detected. In another example, such an action map may provide for irrigation of dry sub-regions. In another example, such an action map may provide for fertilization for sub-regions with a lower crop yield.

Such digital action maps can be used to have processing machines carry out the actions provided for in an action map at least partially automatically.

If a processing machine is moving in an agricultural region, the position of the processing machine can be determined by means of satellite positioning and the actions provided for a sub-region according to the digital action map can be carried out automatically when the processing machine reaches the corresponding sub-region.

Often, the digital action maps are based on position data supplied by a different device than the position data on the basis of which the processing machine performs actions. For example, the position data underlying the digital action maps may originate from a satellite and/or a manned and/or unmanned flying object, while the position data of the processing machine usually originate from a GPS sensor (or a comparable sensor) connected to the processing machine.

Precision agriculture requires that the position data that the processing machine uses to perform actions matches the position data on which the digital action map is based.

In practice, however, it turns out that deviations may occur. Such deviations can mean that the actions will be performed at least in part in the wrong place.

Another problem arises from the fact that for many actions, the position within an agricultural region alone is not sufficient to perform an action in such a way as to achieve an optimal result. Instead, to perform an action, device parameters must be determined that achieve the best possible result. This shall be explained using an example.

An action performed by a processing machine usually affects a defined sub-region. When controlling weeds, for example, it may be worthwhile to spray with a herbicide only the plants in a field actually identified as weeds, while surrounding regions should be excluded from herbicide treatment. In addition to the instructions on the digital action map, device parameters determine which regions are affected by an action. In the example of herbicide treatment, device parameters can determine how fast a processing machine moves in a region, at what time a valve is opened for dispensing herbicide, at what time the valve is closed, how many valves are opened and/or closed, the pressure at which the herbicide is applied and the like. All of these device parameters can influence which sub-regions are affected by an action.

If, for example, a processing machine opens a valve when the processing machine is located in a sub-region in which a herbicide is to be applied according to the action map, and the pressure for applying the herbicide only builds up slowly, it is possible that the sub-region will be only partially treated with herbicide.

In addition to correct position determination, it is therefore necessary to have the correct device parameters available in order to correctly perform the actions provided for in a digital action map, or to achieve an optimal result in the context of precision agriculture.

This problem is solved by the subjects of the independent claims. Preferred embodiments are found in the dependent claims, the present description and the drawings.

In a first aspect, the present invention provides a method comprising the steps of:
creating a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter,
transmitting the digital action map to the at least one processing machine and/or performing the at least one action according to the digital action map by means of the at least one processing machine,
receiving and/or determining a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was/is determined by means of one or more sensors, wherein the one or more sensors detect/s one or more effects of the processing machine as a result of executing the at least one action on the at least one actual sub-region of the Earth's surface,
determining a deviation between the at least one actual sub-region and the at least one target sub-region,
modifying the at least one value of the at least one device parameter with regard to reducing the deviation and/or modifying the digital action map with regard to reducing the deviation.

The present invention further provides a computer system comprising
a control and calculation unit,
a transceiver unit and
a data memory,
   wherein the control and calculation unit is configured:
to create a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter,
to cause the transceiver unit to transmit the digital action map to the at least one processing machine,
to cause the transceiver unit to receive a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was determined by means of one or more sensors, wherein the one or more sensors detect/s one or more effects of the processing machine as a result of executing the at least one action on the at least one actual sub-region of the Earth's surface,
to determine a deviation between the actual sub-region and the target sub-region,
to modify the at least one value of the at least one device parameter with regard to reducing the deviation and/or to modify the digital action map with regard to reducing the deviation,
to include the at least one modified value of the at least one device parameter in the modified action map and/or to store the at least one modified value of the at least one device parameter and/or the modified digital action map in the data memory and/or to transmit the at least one modified value of the at least one device parameter and/or the modified digital action map to the at least one processing machine.

A further subject of the present invention is a computer program product comprising a data memory, wherein the data memory comprises a computer program that can be loaded into a main memory of a computer system and causes the computer system to execute the following steps:
creating a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter,
transmitting the digital action map to the at least one processing machine,
receiving a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was determined by means of one or more sensors, wherein the one or more sensors detect/s one or more effects of the processing machine as a result of executing the at least one action on the at least one actual sub-region of the Earth's surface,
determining a deviation between the actual sub-region and the target sub-region,
modifying the at least one value of the at least one device parameter with regard to reducing the deviation and/or modifying the digital action map with regard to reducing the deviation,
storing the at least one modified value of the at least one device parameter and/or the modified digital action map in a data memory and/or including the at least one modified value of the at least one device parameter in the modified action map and/or transmitting the at least one modified value of the at least one device parameter and/or the modified digital action map to the at least one processing machine.

A further object of the present invention is a system comprising a computer system and one or more sensors for detecting one or more effects of at least one processing machine as a result of executing at least one action on at least one actual sub-region of the Earth's surface, wherein the computer system comprises:
a control and calculation unit,
a transceiver unit and
a data memory,
   wherein the control and calculation unit is configured:
to create a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter,
to cause the transceiver unit to transmit the digital action map to the at least one processing machine,
to cause the transceiver unit to receive a result, wherein the result comprises the at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was determined by means of the one or more sensors, wherein the one or more sensors detect/s one or more effects of the processing machine as a result of executing the at least one action on the at least one actual sub-region of the Earth's surface,
to determine a deviation between the actual sub-region and the target sub-region,
to modify the at least one value of the at least one device parameter with regard to reducing the deviation and/or to modify the digital action map with regard to reducing the deviation,
to include the at least one modified value of the at least one device parameter in the modified action map and/or to store the at least one modified value of the at least one device parameter and/or the modified digital action map in the data memory and/or to transmit the at least one modified value of the at least one device parameter and/or the modified digital action map to the at least one processing machine.

The invention will be more particularly elucidated below without distinguishing between the subjects of the invention (method, computer system, computer program product, system). On the contrary, the following elucidations are intended to apply analogously to all the subjects of the invention, irrespective of in which context (method, computer system, computer program product, system) they occur.

Where steps are stated in an order in the present description or in the claims, this does not necessarily mean that the invention is limited to the order stated. Instead, it is conceivable that the steps are also executed in a different order or else in parallel with one another, the exception being when one step builds on another step, thereby making it imperative that the step building on the previous step be executed next (which will however become clear in the individual case). The orders stated are thus preferred embodiments of the invention.

The present invention provides means for calibrating a processing machine. Such a processing machine is preferably a machine which is used in agriculture to process a region used for agriculture. This description does not distinguish between agriculture, forestry, pastoral farming and other forms of land use. The terms agriculture/agricultural are intended to cover any land use for economic and/or ecological purposes.

Such a processing machine can be, for example, a crop protection device (crop sprayer), a fertilizer spreader, a tiller, a cultivator, a plow, a planter, a seeder, a mower, a mulcher, a manned or unmanned aerial vehicle (UAV, also referred to as a drone) equipped with one or more sensors, and/or the like.

Preferably, the processing machine is a machine for distributing seeds, crop protection products, plant nutrients (e.g. fertilizers) and/or water (for irrigation).

The processing machine is equipped with means that allow it to move in or over the agricultural region. The processing machine can be implemented as a vehicle or an aircraft (e.g. a drone) or a robot. The processing machine can be controlled by a person or move autonomously.

Preferably, the processing machine comprises means for position determination. Preferably, the position determination is based on a satellite navigation system, preferably a global satellite navigation system (Global Navigation Satellite System, abbreviation: GNSS). Examples of global navigation satellite systems are NAVSTAR GPS, GLONASS, Galileo and Beidou. Preferably, the processing machine has a sensor for receiving signals of a satellite navigation system, colloquially referred to as a GPS sensor.

Preferably, the position determination system has methods for real-time kinematics (RTK) for the precise determination of position coordinates in the centimeter range.

The processing machine is configured to perform at least one action. The at least one action is usually an action performed in agriculture in a region where crops are grown or intended to be grown, in order to improve the quality of the soil, to increase the health of the crops grown/to be grown, increase biodiversity in the region, increase crop yield and/or quality and/or to prevent the spread of pests and/or plant diseases. It may also be an action for the purpose of determining characteristics of the soil and/or of the cultivated plants, and/or an action designed to identify and/or characterize and/or quantify pests and/or pathogens in a sub-region.

In a first step an action map is created for a region. The region is preferably a part of the Earth's surface that is or can be used for agriculture. It is preferably a field for growing crop plants. The term “crop plant” is understood to mean a plant which is specifically grown as a useful plant or ornamental plant by human intervention.

A digital action map is a representation of the region of the Earth's surface. The term “digital” means that the action map can be processed by a machine, generally a computer system. “Processing” is understood to mean the known methods for electronic data processing (EDP).

Typically, the digital action map is a grid-like arrangement of image points (pixels) or volume elements (voxels). Each pixel/volume element usually represents a sub-region of the Earth's surface. Accordingly, position data (e.g. geocoordinates) can be assigned to each pixel/volume element, indicating where the sub-region represented by the pixel/volume element is located on the Earth's surface.

At least one sub-region is indicated in a digital action map. In the present description, this sub-region is also referred to as a target sub-region. The target sub-region is indicated by a position on the Earth's surface and by a size and/or shape and/or extent in one or more directions. In addition, at least one action is assigned to the target sub-region in the digital action map. The at least one action specifies which action(s) should be performed in the sub-region by one or more processing machines. Preferably, the at least one action is the application of a substance or multiple substances. Preferably, the at least one substance is a solid or a liquid or suspension; most particularly preferably a liquid or suspension. For example, an aqueous liquid or suspension can be applied, i.e. a liquid/suspension with water as one of the components. Preferably, water is the main component.

In a preferred embodiment, the at least one action comprises the application of a dye, for example, a liquid or suspension comprising a dye, or a dye in solid form. Preferably, this will be a dye that contrasts with the soil and/or any plants growing in the soil. It is preferably a yellow, golden, orange, pale read, pink, red, purple, or blue dye and/or a dye with a metallic sheen. In a preferred embodiment, the dye is a fluorescent and/or phosphorescent dye which, when irradiated with electromagnetic radiation of a defined wavelength range, emits electromagnetic radiation itself (usually of a different wavelength range), and is thus easier to detect than a dye which does not emit but merely reflects/scatters electromagnetic radiation.

The sub-region can be in the form of a point. In such a case, the sub-region can only be specified by a position (e.g. in the form of geocoordinates) on the Earth's surface. The sub-region can be extended in one or more dimensions. Such an extension can run along the Earth's surface or perpendicular to the Earth's surface (e.g., in the direction of the Earth's center or away from the Earth's center) or in another direction. For example, the sub-region can be a straight line, a curve, a surface, or a volume. If the subregion extends in one or more dimensions, then in addition to a position (e.g. in the form of geocoordinates) the subregion can be specified by the respective extent in each dimension. Preferably, the sub-region is in the form of a point or a surface. In a two-dimensional sub-region, the sub-region preferably has the shape of a circle, an ellipse, a square, a rectangle, a parallelogram, a trapezoid or a triangle. However, the subregion may also have a different shape.

If the at least one sub-region is a volume, this may be, for example, cuboid, cylindrical, pyramid, tetrahedral or spherical, or have the shape of an ellipsoid or other shape.

In addition to the indication in the digital action map, the sub-region can also be indicated on the Earth's surface. The sub-region may be indicated, for example, by an object (e.g. a physical object), which fills and/or covers and/or overlaps at least a proportion of the sub-region and/or delimits the sub-region from one or more surrounding sub-regions. The sub-region can be indicated by a measuring rod, a guide cone or another position marker, for example. The sub-region may be indicated by marking it with a dye and/or a string cord.

In a preferred embodiment, the sub-region is provided with one or more sensors. Such a sensor can be used to detect, qualitatively and/or quantitatively, the execution of an action. Such a sensor may be formed, for example, by a liquid sensor, a sensor for electromagnetic radiation, a temperature sensor, an acoustic sensor, a sensor for electrical voltage and/or electric current and/or electric fields, a sensor for magnetic fields, a pH sensor, a sensor for specific substances in the air and/or in the soil and/or the like.

Preferably, the at least one sensor is part of a sensor unit which, in addition to the at least one sensor, comprises a power supply (e.g. in the form of an electrochemical cell, a solar cell, a fuel cell, a wind generator and/or a supercapacitor) and a transmitter unit for transmitting sensor data preferably via radio (e.g. via a mobile radio network). The term sensor is also intended to include indicators that indicate (make visible) a status and/or a change in status. Examples of such an indicator are a humidity indicator (see e.g. EP3177250A1), a pH indicator (see e.g. EP2452987A1), a light indicator (see e.g. DE4213493A1) and a temperature indicator (see e.g. EP0116584A1).

Preferably, a multiplicity of sub-regions is indicated in the digital action map. The term “multiplicity” means more than one. Preferably, more than ten sub-regions are indicated.

Preferably, sub-regions are selected according to a predefined procedure. For example, the sub-regions may be distributed in the region in the form of a pattern. Such a pattern can be, for example, a triangular, square or hexagonal grid. Such a pattern may also have the form of concentric circles or a spiral shape. Preferably, the sub-regions are distributed in the region such that for any three arbitrarily selected sub-regions, two sub-regions never have the same distance from each other. However, it is also possible for the sub-regions to be selected arbitrarily and/or randomly.

The selection of at least one sub-region can be made in the action map and/or in the region of the Earth's surface represented by the action map. The selection of the at least one sub-region can be made, for example, by a user of a computer system. The user can view the action map on a monitor of the computer system. Using input devices such as a keyboard, a computer mouse, a touch-sensitive surface, a microphone, a trackball and/or the like, the user can draw the at least one sub-region in the action map. The computer system can also be configured to draw the at least one sub-region itself in the action map. The computer system can be configured to draw the at least one sub-region in the action map according to predetermined rules. A combination of the selection of the at least one sub-region by a user and by a computer system is also conceivable; for example, it is conceivable that the computer system generates a suggestion that the user can accept or modify; it is also conceivable that the user specifies one or more sub-regions and that the computer draws one or more further sub-regions on the basis of the specified sub-region/sub-regions. For example, a computer system may be configured to distribute a predetermined number of sub-regions over a region of the Earth's surface in such a way that the positions of the sub-regions are evenly distributed over the region or are each a maximum distance from positions of adjacent sub-regions.

Once the selection of the at least one sub-region in the region of the Earth's surface represented by the action map is made, a person can specify the at least one sub-region on the Earth's surface arbitrarily or according to defined rules. To do this, they can locate the at least one sub-region and determine and record the position of the sub-region using a positioning system. The position can then be incorporated into the digital action map. The person can also mark the sub-regions and/or indicate them with one or more objects. It is also possible that the at least one sub-region is defined or located by a processing machine and the position of the sub-region is recorded by means of a position determination system. It is also possible that in a first step, the at least one sub-region is defined and marked on the Earth's surface by a human being or by a processing machine, and/or indicated using one or more objects. In a second step, the at least one indicated sub-region can then be detected by a processing machine, preferably by an aircraft (e.g. a drone) and the position of the at least one sub-region can be determined. The determined position can be incorporated into the action map.

Preferably, the at least one action which is to be performed in the sub-region by at least one processing machine is/are the same action(s) in all sub-regions of the plurality of sub-regions.

The at least one operation is performed by the at least one processing machine. The target sub-region determines the point/points on the Earth's surface at which the at least one action will be performed. In addition, however, device parameters also affect the position(s) where the at least one action will be performed.

The digital action map may have one or more values and/or value ranges for device parameters; however, it is also conceivable that the action map will not include information on device parameters. Preferably, the digital action map comprises at least one value of at least one device parameter.

In the event that the at least one action involves the application of a fluid, the device parameters may include, for example, the following information: number of nozzles from which the liquid exits, distance of the nozzles from one another, pressure upstream of the nozzles, type of nozzles, height of the nozzles above the ground, angle of exit of the liquid in relation to the direction of gravity, outlet shape, outlet width, outlet quantity, speed of the processing machine above the ground, and/or the like.

In a further step, the digital action map is transmitted to the at least one processing machine. The transmission can be carried out, for example, by the digital action map being first stored by the computer system on which/by means of which the digital action map has been generated, on a removable data carrier (e.g. on a USB mass storage device, USB=Universal Serial Bus). The removable data carrier can then be connected to a control unit of the processing machine. However, it is also possible for the digital action map to be transmitted from the computer system to the control unit by radio (e.g. via a Bluetooth connection, a WLAN (=Wireless Local Area Network), a mobile radio connection, an infrared interface or via another wireless communication connection or via a combination of different communication connections.

In a further step, the at least one processing machine carries out the at least one action according to the action map and on the basis of at least one value of at least one device parameter.

The action can be performed automatically, i.e. without any human intervention. The execution can also be partially automatic, i.e. there are some actions that are carried out by the processing machine without any human intervention and some actions that require human intervention. Such partial automation can consist, for example, of a person controlling the processing machine through the region and in doing so activating one or more target sub-regions. The position of the processing machine in the region is recorded and tracked by means of a positioning system. When a target subregion is reached, the processing machine automatically performs one or more actions (measures). However, it is also conceivable that the processing machine moves autonomously through the region and autonomously activates the target sub-region or target sub-regions and performs the at least one action autonomously when a target sub-region is reached.

Performing the at least one action by the at least one processing machine leads to a result. The result includes information about one or more effects of the at least one processing machine on one or more actual sub-regions as a result of the performance of the at least one action. This means that at least one actual sub-region is affected by the result. If the at least one action comprises, for example, the application of a liquid in a target sub-region, the liquid wets an actual sub-region of the Earth's surface.

It is also possible that the liquid penetrates a defined depth into the Earth's surface in the actual sub-region. If the at least one action comprises, for example, the application of a solid in a target sub-region, then the applied solid covers an actual sub-region of the Earth's surface.

If there are a plurality of target sub-regions, there is usually a corresponding actual sub-region for each target sub-region, which is affected by the effects of the at least one action which is to be carried out in the target sub-region according to the digital action map.

Ideally, each actual sub-region corresponds to the corresponding target sub-region. In other words: ideally, at least one processing machine performs the at least one action in each target sub-region exactly as intended.

Usually, however, there are deviations from this; usually not every actual sub-region matches each corresponding target sub-region.

In a further step, one or more deviations between the at least one actual sub-region and the at least one target sub-region are determined.

For example, it may be the case that an actual sub-region will have a different size than the corresponding target sub-region; for example, it may be smaller or larger. It is possible that an actual sub-region will have a different shape than the corresponding target sub-region. It is possible that the position of an actual sub-region does not match the position of the corresponding target sub-region. It may be the case that an actual sub-region has an extent in one or more directions that differs from the corresponding extent of the corresponding target sub-region.

One or more deviations can be determined by analyzing which actual sub-region of the Earth's surface is affected by the action and whether the affected actual sub-region corresponds to a target sub-region. When applying a fluid, for example, it can be determined which actual sub-region is wetted by the fluid and/or how deeply the fluid has penetrated. When applying a solid, it is possible to determine which actual region is covered by the solid. The analysis can be facilitated by the fact that the liquid or solid, as described above, comprises a dye, so that the wetted/covered area is easier to identify: only the wetted/covered area is provided with dye. However, it is also possible that, as described above, one or more sensors are arranged in and/or around the target sub-region, which provide information about which positions the liquid has reached. The sub-region for which the analysis indicates that it is affected by the at least one action is the actual sub-region. This actual sub-region is compared with the target sub-region and one or more deviations between the actual sub-region and the target sub-region are determined with respect to their respective position, size and/or shape and/or extent in one or more directions.

From the deviations, a device parameter or a plurality of device parameters can be determined, the value/values of which must be changed in order to reduce the deviations, i.e. in order in the ideal case make each actual sub-region coincide with the corresponding target sub-region.

If the position of an actual sub-region does not match the position of the corresponding target sub-region, but has an offset, for example, then one or more values of one or more device parameters of the position determination system of the processing machine can be changed.

If the actual sub-region is smaller or larger than the target sub-region and/or if it has a different shape, then at least one value for at least one device parameter that has an influence on the shape and/or size of the sub-region can be modified to reduce the deviations. For example, during the application of a liquid, the number of nozzles, the pressure at which the liquid is applied, the speed of movement of the at least one processing machine, the time at which one or more valves are opened and/or closed, and/or other values of device parameters are changed.

The at least one modified value of the at least one device parameter can be stored in a data memory and/or be incorporated into a modified digital action map and/or transmitted to the at least one processing machine.

However, it is also possible to adapt (modify) the digital action map in order to reduce the deviations. If the position of the at least one target sub-region does not match the position of the at least one actual sub-region, the coordinates (position data) of the at least one target sub-region in the digital action map can be replaced by the coordinates (position data) of the at least one actual sub-region. The adapted (modified) digital action map can be stored in a data memory and/or transmitted to the at least one processing machine.

The determination of modified values of device parameters and/or a modified digital action map constitutes a calibration. At least one additional action can be performed in the region after calibration. Based on the modified digital action map, a new action map can be created, in which at least one action is recorded for at least one sub-region. The new action map can be sent to at least one processing machine. On the basis of the new digital action map and at least one modified value of at least one device parameter (if present in the modified action map), the processing machine can carry out the at least one action recorded in the new digital action map. It can be checked whether the modification of the values of the device parameters and/or the digital action maps leads to a reduced deviation of the at least one actual sub-region from the at least one target sub-region.

The invention is explained in more detail below with reference to drawings, without wishing to restrict the invention to the features and combinations of features that are shown in the drawings.

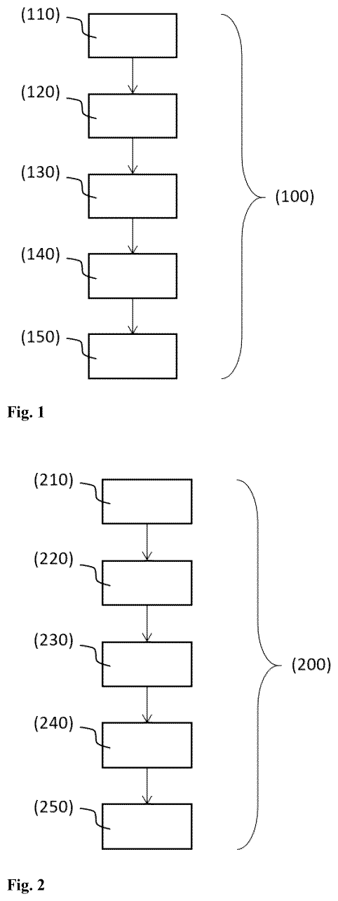

FIG. 1 shows, in schematic form, an embodiment of the method according to the invention in the form of a flow chart. The method (100) comprises the following steps:
(110) creating a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value for at least one device parameter,
(120) transmitting the digital action map to the at least one processing machine,
(130) receiving a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was determined by means of one or more sensors, wherein the one or more sensors detect/s one or more effects of the processing machine as a result of executing the at least one action on the at least one actual sub-region of the Earth's surface,
(140) determining a deviation between the at least one actual sub-region and the at least one target sub-region in relation to the respective position and size and/or shape and/or extent in one or more directions,
(150) modifying the at least one value of the at least one device parameter with regard to reducing the deviation and/or modifying the digital action map with regard to reducing the deviation.

In one embodiment, the method (100) comprises a further step (160), which follows step (150):
(160) storing the at least one modified value of the at least one device parameter and/or the modified digital action map and/or including the at least one modified value of the at least one device parameter in the modified digital action map and/or transmitting the at least one modified value and/or the modified digital action map to the at least one processing machine.

The method (100) can be carried out completely by a computer system (for example, the computer system according to the invention). In one embodiment, the method (100) is thus a computer-implemented method. It is conceivable that a computer program comprises instructions to a computer system, which cause the computer system to carry out steps (110) to (160) of the method (100).

However, the method according to the invention may also comprise steps that cannot be carried out by a computer system. FIG. 2 shows an example in the form of a flow diagram. The method (200) shown in FIG. 2 comprises the steps:
(210) creating a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value for at least one device parameter,
(220) performing the at least one action by means of the at least one processing machine in accordance with the digital action map,
(230) determining a result of the at least one action in at least one actual region, wherein the at least one actual sub-region indicates in which sub-region/sub-regions of the Earth's surface the at least one action was carried out by the at least one processing machine, wherein the at least one actual sub-region is characterized by a size and/or shape and/or extent in one or more directions, wherein the result is determined by means of one or more sensors, wherein the one or more sensors detect/s one or more effects of the processing machine as a result of executing the at least one action on the at least one actual sub-region of the Earth's surface,
(240) determining a deviation between the at least one actual sub-region and the at least one target sub-region in relation to the respective position and size and/or shape and/or extent in one or more directions,
(250) modifying the at least one value of the at least one device parameter with regard to reducing the deviation and/or modifying the digital action map with regard to reducing the deviation.

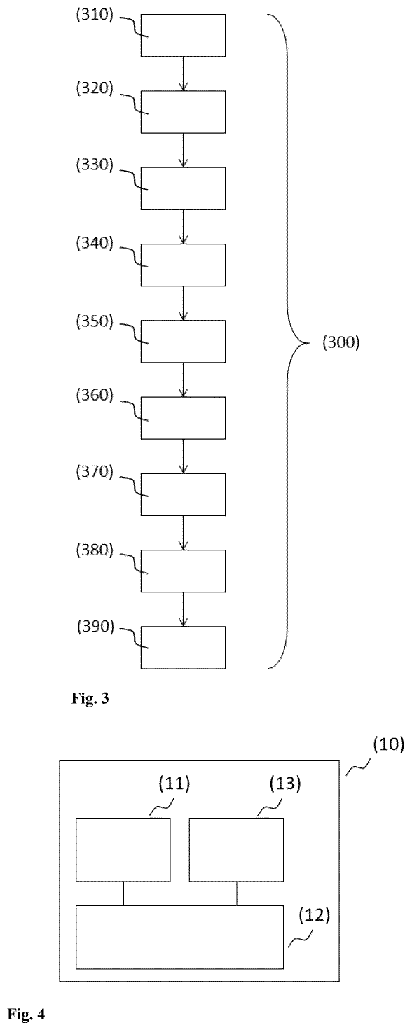

FIG. 3 shows, in schematic form, a further embodiment of the method according to the invention in the form of a flow chart. The method (300) shown in FIG. 3 comprises the following steps:
(310) indicating a plurality of sub-regions of the Earth's surface,
(320) detecting positions of the indicated sub-regions on the Earth's surface, preferably by means of an unmanned aircraft,
(330) creating a digital action map, wherein the identified sub-regions are indicated as target sub-regions in the digital action map, wherein each target sub-region is indicated in the digital action map by a detected position on the Earth's surface as well as by a size and/or shape and/or extent in one or more directions, wherein at least one action is recorded for each target sub-region, which action is to be carried out in the target sub-region by at least one processing machine on the basis of at least one value for at least one device parameter,
(340) transmitting the digital action map to the at least one processing machine and/or carrying out the at least one action according to the digital action map by means of the at least one processing machine,
(350) receiving and/or determining a result of the at least one action in at least one actual region, wherein the at least one actual sub-region indicates in which sub-region/sub-regions of the Earth's surface the at least one action was carried out by the at least one processing machine, wherein the at least one actual sub-region is characterized by a size and/or shape and/or extent in one or more directions, wherein the result is determined by means of one or more sensors, wherein the one or more sensors detect/s one or more effects of the processing machine as a result of executing the at least one action on the at least one actual sub-region of the Earth's surface,
(360) determining deviations between the actual sub-regions and target sub-regions in relation to the respective position and size and/or shape and/or extent in one or more directions,
(370) modifying the at least one value of the at least one device parameter with regard to reducing deviations and/or modifying the digital action map with regard to reducing deviations,
(380) storing the at least one modified value of the at least one device parameter and/or the modified digital action map and/or including the at least one modified value of the at least one device parameter in the modified digital action map and/or transmitting the at least one modified value and/or the modified digital action map to the at least one processing machine.

The step (320) of “detecting positions of the indicated sub-regions” can be carried out, for example, by means of an unmanned aircraft which moves autonomously over the region and the markings can be detected by means of a camera or cameras, and position data (e.g. geocoordinates) for the markings can be acquired by means of a position determination system. The position data determined by the unmanned aircraft for the sub-regions identified by means of the markings can be used to create the digital action map.

The at least one action can be, for example, the application of a liquid or a solid or a suspension. For example, the liquid may be water or an aqueous solution of a dye. The suspension and/or the solid may comprise a dye.

The “determination of a result” in step (360) may include, for example, the identification of sub-regions wetted with liquid and/or the depth of a liquid that has penetrated into the Earth's surface or of solid-covered sub-regions. The liquid and/or the solid can be detected, for example, by means of one or more sensors in the sub-regions. If an indicator is applied in the sub-regions, the wetted/covered sub-region can be detected, for example, by means of a color change. If the applied liquid/solid contains a dye, the wetted sub-regions can be detected from the dye present there. A result that is expressed in visible features (e.g. dye, color change) can be automatically detected, e.g. by means of one or more cameras.

It is possible that the result is detected by the unmanned aircraft preferably used in step (320). This aircraft can move over the region again after the at least one action has been performed by the at least one processing machine and automatically detect the sub-regions that are affected by the at least one action.

To detect indicated sub-regions and/or sub-regions which are imaged in a photograph taken by a camera and are affected by an action, machine learning models which have been trained on the basis of a plurality of training images can be used to learn markings and/or the effects of actions. Details can be found in the multitude of publications on the subject of object recognition in images (see e.g. J. Brownlee: Deep Learning for Computer Vision, Machine Learning Mastery, 2020).

Further embodiments of the present invention are:

(1) A method comprising the steps of:
creating a digital action map for a region, wherein at least one target sub-region is indicated in the digital action map, wherein at least one action for the target sub-region is recorded in the digital action map, which action is to be carried out in the target sub-region by at least one processing machine on the basis of device parameters,
transmitting the digital action map to the at least one processing machine,
receiving a result, wherein the result comprises an actual sub-region, wherein the actual sub-region indicates in which sub-region the at least one action was performed by the at least one processing machine,
determining a deviation between the actual sub-region and the target sub-region,
modifying the device parameters with regard to reducing the deviation and/or modifying the digital action map with regard to reducing the deviation.

(2) The method according to embodiment (1), furthermore comprising the following steps:
indicating a plurality of sub-regions of the Earth's surface,
detecting positions of the indicated sub-regions on the Earth's surface, preferably by means of an unmanned aircraft,
creating the digital action map, wherein the indicated sub-regions are indicated as target sub-regions in the digital action map.

(3) The method according to either of embodiments (1) or (2), furthermore comprising the steps of:
performing the actions recorded in the digital action map by means of the at least one processing machine,
recording a result, wherein the result comprises a plurality of actual sub-regions, wherein the actual sub-regions indicate in which sub-regions the at least one action was performed by the at least one processing machine.

(4) The method according to any one of the embodiments (1) to (3), furthermore comprising the step of:
storing the modified device parameters and/or the modified digital action map.

(5) The method according to any one of embodiments (1) to (4), furthermore comprising the steps of:
creating a new digital action map, wherein at least one action for at least one sub-region is recorded in the new digital action map, which action is to be carried out in the at least one sub-region by the at least one processing machine on the basis of the modified device parameters,
transmitting the new digital action map to the at least one processing machine,
performing the actions recorded in the new digital action map by the at least one processing machine on the basis of the modified device parameters.

(6) The method according to any one of embodiments (1) to (5), furthermore comprising the steps of:
arranging one or more sensors in the indicated sub-region,
recording the result using the one or more sensors.

(7) The method as claimed in any one of embodiments (1) to (6), wherein the region is a field for the cultivation of crop plants.

(8) The method as claimed in any one of claims (1) to (7), wherein the at least one action comprises the application of a liquid in the at least one target sub-region.

(9) A system comprising
a control and calculation unit,
a transceiver unit and
a data memory,
   wherein the control and calculation unit is configured:
to create a digital action map for a region, wherein at least one target sub-region is indicated in the digital action map, wherein at least one action is recorded in the digital action map for the target sub-region, which action is to be carried out in the target sub-region by at least one processing machine on the basis of device parameters,
to cause the transceiver unit to transmit the digital action map to the at least one processing machine,
to cause the transceiver unit to receive a result, wherein the result comprises an actual sub-region, wherein the actual sub-region indicates in which sub-region the at least one action was performed by the at least one processing machine,
to determine a deviation between the actual sub-region and the target sub-region,
to modify the device parameters with regard to reducing the deviation and/or to modify the digital action map with regard to reducing the deviation,
to store the modified device parameters and/or the modified digital action map in the data memory.

(10) The system according to embodiment (9), further comprising
a processing machine, wherein the processing machine is preferably a machine for spreading seeds, crop protection agents, plant nutrients and/or water.

(11) The system according to embodiment (9) or (10), further comprising
an unmanned aircraft comprising a camera and a positioning system, wherein the unmanned aircraft is configured to move over the region and
   to acquire markings of sub-regions and to determine position data for the markings, and/or
   to record the result of the at least one action in the region.

(12) A computer program product comprising a data memory, wherein the data memory comprises a computer program that can be loaded into a main memory of a computer system and causes the computer system to execute the following steps:
creating a digital action map for a region, wherein at least one target sub-region is indicated in the digital action map, wherein at least one action for the target sub-region is recorded in the digital action map, which action is to be carried out in the target sub-region by at least one processing machine on the basis of device parameters,
transmitting the digital action map to the at least one processing machine,
receiving a result, wherein the result comprises an actual sub-region, wherein the actual sub-region indicates in which sub-region the at least one action was performed by the at least one processing machine,
determining a deviation between the actual sub-region and the target sub-region,
modifying the device parameters with regard to reducing the deviation and/or modifying the digital action map with regard to reducing the deviation,
storing the modified device parameters and/or the modified digital action map in a data memory.

The present invention can be embodied wholly or partly by means of one or more computer systems. A “computer system” is an electronic data processing device that processes data by way of programmable computing rules. Such a system typically comprises a “computer”, which is the unit that includes a processor for carrying out logic operations, and peripherals.

In computer technology, a “peripheral” means any device connected to the computer that is used to control the computer and/or functions as an input and output device. Examples thereof are monitor (screen), printer, scanner, mouse, keyboard, drives, camera, microphone, speakers, etc. Internal ports and expansion cards are also regarded as peripherals in computer technology.

Modern computer systems are frequently divided into desktop PCs, portable PCs, laptops, notebooks, netbooks and tablet PCs, and what are called handhelds (for example smartphones); all of these systems may be used to implement the invention.

The inputs to the computer are made using input devices such as a keyboard, mouse, touch-sensitive screen (touchscreen), a microphone and/or the like.

The output is typically provided via a display, a printer, a speaker, and/or by storage in a data storage device.

FIG. 4 shows by way of example and in schematic form a computer system according to the present invention.

The computer system (10) shown in FIG. 4 comprises a transceiver unit (11), a control and calculation unit (12) and an output unit (13).

The control and calculation unit (12) serves for control of the computer system (10), for coordination of the data flows between the units of the computer system (10), and for the performance of calculations.

The control and calculation unit (12) is configured (for example by means of the computer program according to the invention):
to create a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter,
to cause the transceiver unit (11) to transmit the digital action map to the at least one processing machine,
to cause the transceiver unit (11) to receive a result, wherein the result comprises at least one actual sub-region, wherein the at least one actual sub-region indicates in which sub-region/sub-regions of the Earth's surface the at least one action was carried out by the at least one machining tool, wherein the at least one actual sub-region is characterized by a position on the Earth's surface and by a size and/or shape and/or extent in one or more directions, wherein the result was determined by means of one or more sensors, wherein the one or more sensors detect/s one or more effects of the processing machine as a result of executing the at least one action on the at least one actual sub-region of the Earth's surface,
to determine a deviation between the actual sub-region and the target sub-region,
to modify the at least one value of the at least one device parameter with regard to reducing the deviation and/or to modify the digital action map with regard to reducing the deviation, and
to cause the output unit (13) to incorporate the at least one modified value of the at least one device parameter in the modified digital action map and/or to store the at least one modified value of the at least one device parameter and/or the modified digital action map in the data memory and/or to cause the transceiver unit (11) to transmit the at least one modified value of the at least one device parameter and/or the modified digital action map to the at least one processing machine.

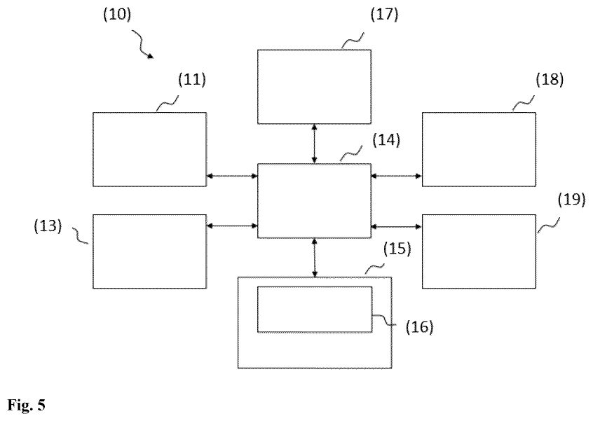

FIG. 5 shows in schematic form a further embodiment of the computer system (10) according to the invention.

The computer system (10) shown in FIG. 5 comprises a processing unit (14) connected to a storage medium (15). The processing unit (14) and the storage medium (15) form a control and calculation unit (12), as shown in FIG. 4.

The processing unit (14) may comprise one or more processors alone or in combination with one or more storage media (15). The processing unit (14) can be customary computer hardware that is able to process information such as e.g. a digital action map, position data, sensor data, digital image recordings, computer programs and/or other digital information. The processing unit (14) normally consists of an arrangement of electronic circuits, some of which can be designed as an integrated circuit or as a plurality of integrated circuits connected to one another (an integrated circuit is sometimes also referred to as a “chip”). The processing unit (14) can be configured to execute computer programs that can be stored in a main memory of the processing unit (14) or in the storage medium (15) of the same or a different computer system.

The storage medium (15) can be customary computer hardware that is able to store information, such as e.g. values for device parameters, digital action maps, sensor data, position data, digital image recordings, computer programs and/or other digital information, either temporarily and/or permanently. The storage medium (15) may comprise a volatile and/or non-volatile memory and may be fixed in place or removable. Examples of suitable storage media are RAM (random access memory), ROM (read-only memory), a hard disk, a flash memory, an exchangeable computer floppy disk, an optical disc, a magnetic tape or a combination of the aforementioned. Optical discs can include compact discs with read-only memory (CD-ROM), compact discs with read/write function (CD-R/W), DVDs, Blu-ray discs and the like.

The processing unit (14) may be connected not just to the storage medium (15), but also to one or more interfaces (11, 13, 17, 18, 19) in order to display, transmit and/or receive information. The interfaces can comprise one or more communication interfaces (11, 18) and/or one or more user interfaces (13, 17, 19). The one or more communication interfaces (11, 18) can be configured such that they transmit and/or receive information, e.g. to and/or from a camera, other computers, networks, data storage media or the like. The one or more communication interfaces (11, 18) may be configured to transmit and/or receive information via physical (wired) and/or wireless communication connections. The one or more communication interfaces (11, 18) may comprise one or more interfaces for connection to a network, for example using technologies such as mobile telephone, Wi-Fi, satellite, cable, DSL, optical fiber and/or the like. In some examples, the one or more communication interfaces (11, 18) may comprise one or more close-range communication interfaces configured to connect devices having close-range communication technologies such as NFC, RFID, Bluetooth, Bluetooth LE, ZigBee, infrared (e.g. IrDA) or the like.

The user interfaces (13, 17, 19) may comprise an output unit (13). An output unit (13) may be configured to display information to a user. Suitable examples thereof are a liquid crystal display (LCD), a light-emitting diode display (LED), a plasma display panel (PDP), a printer or the like. The user input interface(s) (13, 17, 19) may be wired or wireless and may be configured to receive information from a user in the computer system (10), for example for processing, storage and/or display. Suitable examples of user input interfaces (17) are a microphone, an image or video recording device (for example a camera), a keyboard or a keypad, a joystick, a touch-sensitive surface (separate from a touchscreen or integrated therein) or the like. In some examples, the user interfaces (13, 17, 19) may contain an automatic identification and data capture technology (19) for machine-readable information. This can include barcodes, radiofrequency identification (RFID), magnetic strips, optical character recognition (OCR), integrated circuit cards (ICC) and the like. The user interfaces (13, 17, 19) may furthermore comprise one or more interfaces for communication with peripherals such as printers and the like.

One or more computer programs (16) may be stored in the storage medium (15) and executed by the processing unit (14), which is thereby programmed to fulfil the functions described in this description. The retrieving, loading and execution of instructions of the computer program (16) may take place sequentially, such that an instruction is respectively retrieved, loaded and executed. However, the retrieving, loading and/or execution may also take place in parallel.

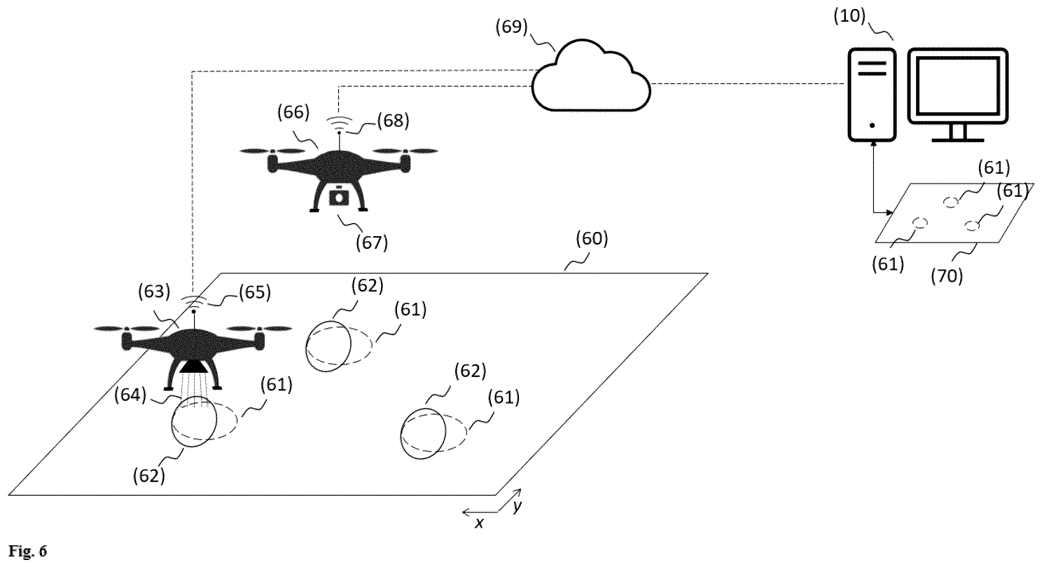

FIG. 6 shows, by way of example and schematically, the interaction of the computer system according to the invention with a processing machine and a sensor.

FIG. 6 shows a region (60) of the Earth's surface. A processing machine (63) moves across the region (60). The processing machine (63) is designed as an unmanned aircraft (drone).

The processing machine (63) is equipped with means (64) for applying one or more substances.

The processing machine (63) further comprises a receiving unit (65), via which the processing machine (63) can receive a digital action map (70) from the computer system (10) according to the invention.

In the example shown in FIG. 6, the computer system (10) according to the invention and the receiving unit (65) of the processing machine (63) are connected to each other via a network (69).

The receiving unit (65) of the processing machine (63) receives data (e.g. the digital action map) via a radio connection (e.g. via a mobile radio connection). The computer system (10) according to the invention may be connected to the network (69) via a cable connection and/or radio connection.

The digital action map (70) is a digital representation of the region (60) of the Earth's surface. Target sub-regions (61) are indicated in the digital action map (70). Each target sub-region is characterized by a position on the Earth's surface and by a size and/or shape and/or extent in one or more directions. In this example, the target sub-regions (61) have the shape of an ellipse. The geocoordinates of the geometric center of gravity of the ellipse can be used as the position of a target sub-region.

In the digital action map (70), at least one action is recorded for each target sub-region (61), which is to be performed in the target sub-region (61) by the processing machine (63) on the basis of device parameters (not explicitly shown in FIG. 6). The at least one action in the present example is the application of one or more substances using the means (64) for applying one or more substances.

The processing machine (63) performs the at least one operation according to the information in the digital action map (70). The result of performing the at least one action includes actual sub-regions (62) in the region (60) of the Earth's surface, which have been treated with one or more substances. The actual sub-regions (62) do not match the target subregions (61). There are deviations present. Although the actual sub-regions (62) also have the shape of an ellipse, the geometric centers of gravity (the positions) do not correspond and the extensions in the x direction and in they direction do not match.

The result of performing the at least one action by the processing machine (63) is detected by means of a sensor (67). In this example, the sensor (67) is a camera mounted on an unmanned aircraft (66). In this example, the sensor (67) moves over the region (60) of the Earth's surface and generates recorded images of the actual sub-regions (62). However, it is also conceivable that one or more sensors are stationed in or above the region (60). The actual sub-regions (62) can be recognized in the image recordings, for example, by the fact that the actual sub-regions (62) reflect electromagnetic radiation (e.g. sunlight) differently, due to the wetting or covering by the one or more substances, than surrounding regions which have not been treated with the one or more substances. The one or more substances may comprise a dye that absorbs a portion of the sunlight, which leads to the fact that the radiation returned by the dye has a characteristic spectrum, from which the dye and thus the actual sub-regions covered with dye can be recognized. The one or more substances may comprise a fluorescent and/or phosphorescent dye, which under excitation by electromagnetic radiation of a defined wavelength range is stimulated to emit electromagnetic radiation with a characteristic spectrum, by means of which the dye and thus the actual sub-regions covered with dye can be recognized. The aircraft (66) may be equipped with a source of electromagnetic radiation, the radiation of which leads, for example, to excitation of a fluorescent and/or phosphorescent dye.

The unmanned aircraft (66) further comprises a transmission unit (66), with which the unmanned aircraft (66) can transmit image recordings of the actual sub-regions (62) acquired by means of the camera (67) to the computer system (10) according to the invention via the network (69).

The computer system (10) according to the invention may be configured to determine deviations of the actual sub-regions (62) from the target sub-regions (61), for example by superimposing the image recording(s) of the actual sub-regions (62) with the digital action map (70).

The computer system (10) according to the invention may be configured to modify values of the device parameters of the processing machine (63) in such a way that the deviations of the actual sub-regions (62) from the target sub-regions (61) are reduced and/or minimized and/or eliminated.

The computer system (10) according to the invention may be configured to modify the digital action map (70) in such a way that the deviations of the actual sub-regions (62) from the target sub-regions (61) are reduced and/or minimized and/or eliminated.

The computer system (10) according to the invention may be configured to store the modified device parameters and/or the modified digital action map in a data memory and/or to transmit them via the network (69) to the processing machine (63).

1. A method for calibrating a machining tool, comprising:
creating a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, wherein the at least one action is to be performed in the target sub-region by at least one processing machine on the basis of at least one value of at least one device parameter;
transmitting the digital action map to the at least one processing machine and/or performing the at least one action according to the digital action map by means of the at least one processing machine;
receiving and/or determining a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result is determined by means of one or more sensors, wherein the one or more sensors detect one or more effects of the processing machine as a result of executing the at least one action on the at least one actual sub-region of the Earth's surface;
determining a deviation between the at least one actual sub-region and the at least one target sub-region; and
modifying the at least one value of the at least one device parameter with regard to reducing the deviation and/or modifying the digital action map with regard to reducing the deviation.

2. The method as claimed in claim 1, further comprising:
creating a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter;
transmitting the digital action map to the at least one processing machine;
receiving a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was determined by means of one or more sensors, wherein the one or more sensors detect one or more effects of the processing machine as a result of executing the at least one action on the at least one actual sub-region of the Earth's surface;
determining a deviation between the at least one actual sub-region and the at least one target sub-region; and
modifying the at least one value of the at least one device parameter with regard to reducing the deviation and/or modifying the digital action map with regard to reducing the deviation,
characterized in that all steps of the method are carried out by a computer system.

3. The method as claimed in claim 1, further comprising:
creating a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter;
carrying out the at least one action according to the digital action map using the at least one processing machine;
determining a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was determined by means of one or more sensors, wherein the one or more sensors detect one or more effects of the processing machine as a result of executing the at least one action on the at least one actual sub-region of the Earth's surface;
determining a deviation between the at least one actual sub-region and the at least one target sub-region; and
modifying the at least one value of the at least one device parameter with regard to reducing the deviation and/or modifying the digital action map with regard to reducing the deviation.

4. The method as claimed in claim 1, further comprising:
storing the at least one modified value of the at least one device parameter and/or the modified digital action map and/or including the at least one modified value of the at least one device parameter in the modified digital action map and/or transmitting the at least one modified value and/or the modified digital action map to the at least one processing machine.

5. The method as claimed in claim 1, further comprising:
creating a new digital action map, wherein at least one action for at least one sub-region is recorded in the new digital action map, which action is to be carried out in the at least one sub-region by the at least one processing machine on the basis of the at least one modified value of the at least one device parameter;
transmitting the new digital action map to the at least one processing machine; and
executing the actions recorded in the new digital action map by means of the at least one processing machine on the basis of the at least one modified value of the at least one device parameter.

6. The method as claimed in claim 2, further comprising:
arranging one or more sensors in and/or on and/or over the at least one target sub-region; and
detecting the result using the one or more arranged sensors.

7. The method as claimed in claim 1, wherein the region is a field for cultivation of crop plants.

8. The method as claimed in claim 1, wherein the at least one action comprises application of a liquid, a suspension, and/or a solid in the at least one target sub-region.

9. The method as claimed in claim 8, wherein the liquid, the suspension and/or the solid comprises a dye.

10. The method as claimed in claim 1, wherein the one or more sensors comprise one or more cameras configured to generate one or more recorded images of the at least one actual sub-region.

11. The method as claimed in claim 10, wherein determining a deviation between the at least one actual sub-region and the at least one target sub-region comprises:
overlaying the one or more recorded images with the digital action map.

12. The method as claimed in claim 1, further comprising:
indicating a plurality of sub-regions of the Earth's surface;
detecting positions of the indicated sub-regions on the Earth's surface
creating a digital action map, wherein the marked sub-regions are indicated as target sub-regions in the digital action map, wherein each target sub-region is characterized in the digital action map by a detected position on the Earth's surface as well as by a size and/or shape and/or extent in one or more directions, wherein at least one action is recorded for each target sub-region, which action is to be carried out in the target sub-region by at least one processing machine on the basis of at least one value of at least one device parameter;
transmitting the digital action map to the at least one processing machine and/or carrying out the at least one action according to the digital action map by means of the at least one processing machine;
receiving and/or determining a result, wherein the result comprises at least one actual region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result is determined by means of one or more sensors, wherein the one or more sensors detect one or more effects of the processing machine as a result of executing the at least one action on the at least one actual sub-region of the Earth's surface;
determining deviations between the actual sub-regions and target sub-regions in relation to the respective position and size and/or shape and/or extent in one or more directions;
modifying the at least one value of the at least one device parameter with regard to reducing deviations and/or modifying the digital action map with regard to reducing deviations; and
storing the at least one modified value of the at least one device parameter and/or the modified digital action map and/or including the at least one modified value of the at least one device parameter in the modified digital action map and/or transmitting the at least one modified value and/or the modified digital action map to the at least one processing machine.

13. A computer system comprising;
a control and calculation unit;
a transceiver unit; and
a data memory,
wherein the control and calculation unit is configured to:
create a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter;
cause the transceiver unit to transmit the digital action map to the at least one processing machine;
cause the transceiver unit to receive a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was determined by means of one or more sensors, wherein the one or more sensors detect one or more effects of the processing machine as a result of executing the at least one action on the at least one actual sub-region of the Earth's surface;
determine a deviation between the actual sub-region and the target sub-region;
modify the at least one value of the at least one device parameter with regard to reducing the deviation and/or to modify the digital action map with regard to reducing the deviation; and
include the at least one modified value of the at least one device parameter in the modified action map and/or to store the at least one modified value of the at least one device parameter and/or the modified digital action map in the data memory and/or to transmit the at least one modified value of the at least one device parameter and/or the modified digital action map to the at least one processing machine.

14. The computer system as claimed in claim 13, wherein the computer system comprises means for carrying out the method as claimed in claim 2.

15. A computer program product comprising a data memory, wherein the data memory comprises a computer program that can be loaded into a main memory of a computer system and causes the computer system to execute the following steps:
creating a digital action map for a region of the Earth's surface, wherein at least one target sub-region is indicated in the digital action map, wherein the target sub-region is characterized by a position on the Earth's surface as well as by a size and/or shape and/or extent in one or more directions, wherein at least one action for the target sub-region is recorded in the digital action map, which action is to be carried out in the target sub-region by at least one processing machine on the basis of at least one value of at least one device parameter;
transmitting the digital action map to the at least one processing machine;
receiving a result, wherein the result comprises at least one actual sub-region, wherein the at least one actual sub-region indicates in which sub-region/sub-regions of the Earth's surface the at least one action was carried out by the at least one processing machine, wherein the at least one actual sub-region is characterized by a position on the Earth's surface and by a size and/or shape and/or extent in one or more directions, wherein the result was determined by means of one or more sensors, wherein the one or more sensors detect one or more effects of the processing machine as a result of executing the at least one action on the at least one actual sub-region of the Earth's surface;
determining a deviation between the actual sub-region and the target sub-region;
modifying the at least one value of the at least one device parameter with regard to reducing the deviation and/or modifying the digital action map with regard to reducing the deviation; and
storing the at least one modified value of the at least one device parameter and/or the modified digital action map in a data memory and/or including the at least one modified value of the at least one device parameter in the modified action map and/or transmitting the at least one modified value of the at least one device parameter and/or the modified digital action map to the at least one processing machine.

16. A system comprising;
a computer system as claimed in claim 13;
one or more sensors for detecting one or more effects of at least one processing machine as a result of executing at least one action on at least one actual sub-region of the Earth's surface, the one or more sensors comprising one or more cameras; and
at least one processing machine.

17. The method of claim 12, wherein positions of the indicated sub-regions on the Earth's surface are detected by means of an unmanned aircraft.
